(19) United States
(12) Patent Application Publication
(10) Pub. No.: US 2025/0214530 A1
(43) Pub. Date: Jul. 3, 2025

(54) BELT RETRACTOR FOR A SEAT BELT OF A MOTOR VEHICLE

(71) Applicant: AUTOLIV DEVELOPMENT AB, Vargarda (DE)

(72) Inventors: Lars CARLSTEDT, Vargarda (SE); Goran KARLSSON, Vargarda (SE); Per AXBLOM, Alingsas (SE); Fredrik FYHR, Vargarda (SE); Arvid AHMAN, Vargarda (SE)

(21) Appl. No.: 18/850,294

(22) PCT Filed: Feb. 16, 2023
(86) PCT No.: PCT/EP2023/053848

§ 371 Date: Sep. 24, 2024

(30) Foreign Application Priority Data
Mar. 29, 2022 (DE) 10 2022 107 342.4

(51) Int. Cl. B60R 22/46; B60R 22/36

(52) U.S. Cl. CPC B60R 22/4676; B60R 22/4628; B60R 22/36

(57) ABSTRACT

The invention relates to a belt retractor for a seatbelt of a motor vehicle, comprising a belt shaft which is rotatably mounted in a housing frame, a profile head which can be locked with respect to the housing frame, a multi-stage first force-limiting device, wherein the first force-limiting device is coupled to the profile head and to the belt shaft, wherein the first force-limiting device allows a force-limited relative rotation of the belt shaft with respect to the locked profile head, and comprising at least one second force-limiting device, wherein, in an initial state, the second force-limiting device is decoupled, so that the force-limited relative rotation of the belt shaft with respect to the locked profile head takes place without a force-limited involvement of the second force-limiting device.

The present invention relates to a belt retractor for a seatbelt of a motor vehicle, comprising a belt shaft which is rotatably mounted in a housing frame, a profile head which can be locked with respect to the housing frame, a multi-stage first force-limiting device, wherein the first force-limiting device can be coupled to the profile head and to the belt shaft, and wherein the first force-limiting device allows a force-limited relative rotation of the belt shaft with respect to the locked profile head, and comprising a second force-limiting device.

A belt retractor having the aforementioned features is known, for example, from WO 2020 021 003 A1, in which a multi-stage first force-limiting device comprises two torsion bars that can be decoupled from one another to set different force-limiting levels. In addition, a second force-limiting device is provided which is coupled to the first multi-stage force-limiting device in an initial state and which can be actively decoupled from the multi-stage first force-limiting device. By means of such a belt retractor, three force-limiting levels can be set for the force-limited relative rotation of the belt shaft.

The problem addressed by the present invention is that of eliminating the disadvantages described with reference to the prior art and in particular of specifying a belt retractor in which the force-limited relative rotation of the belt shaft with respect to the locked profile head is possible with more force-limiting levels.

A solution to this problem is provided by the belt retractor having the features of independent claim 1, further solutions and advantageous developments being specified in the dependent claims and in the description, individual features of the advantageous developments being combinable with one another in a technically reasonable manner.

The problem is solved in particular by a belt retractor having the features mentioned at the outset, in which the second force-limiting device is decoupled in an initial state, so that the force-limited relative rotation of the belt shaft with respect to the locked profile head can take place without a force-limiting involvement of the second force-limiting device.

In other words: The basic idea of the invention is that the second force-limiting device is not directly or indirectly connected to the belt shaft in the starting initial state, so that without an intentional activation of the second limiting device, the force-limited relative rotation of the belt shaft is brought about only by at least one force-limiting element of the first force-limiting device. Thus, the force-limited relative rotation at the beginning of the relative rotation, during the relative rotation and at the end of the relative rotation can take place completely independently of the second force-limiting device.

According to an advantageous development, the invention proposes that the second force-limiting device can be coupled to the profile head and/or to the belt shaft, so that in a then coupled state the force-limited relative rotation of the belt shaft with respect to the locked profile head takes place with force-limiting involvement of the second force-limiting device. It is therefore proposed that the force-limited effect of the second force-limiting device can optionally be added to a stage of the multi-stage first force-limiting device. The number of force-limiting levels achievable by the stages of the first force-limiting device can thus be doubled by the second force-limiting device.

Multi-stage first force-limiting devices are well known from the prior art. For example, a two-stage first force-limiting device can comprise two torsion bars, a switching apparatus being provided via which it is possible to switch, for example by means of a pyrotechnic drive, whether both torsion bars or only one torsion bar is involved in the force-limited relative rotation of the belt shaft. Thus, two force-limiting levels can be set using the first force-limiting device. With regard to the design of a multi-stage first, in particular a two-stage first force-limiting device, reference is made in full to WO 2020 021 003 A1 already mentioned at the outset.

It is in particular proposed that a drive, which can be activated electronically, for example, is provided, by means of which a coupling of the second force-limiting device is possible in such a way that the second force-limiting device is also involved in the force-limited relative rotation of the belt shaft. In this case, it is proposed in particular that the drive is a pyrotechnic drive, by means of which a transfer of the belt retractor from the initial state to a coupled state can be triggered, in which the second force-limiting device is involved in the force-limited relative rotation in addition to the first force-limiting device.

In a preferred embodiment, the second force-limiting device comprises a wheel element which, in the initial state, is rotatably mounted with respect to the housing frame and rotates with the belt shaft and/or an element of the first force-limiting device. In a coupled state, however, the wheel element is blocked in its rotation. The wheel element can, for example, be a gear wheel having teeth on its outer circumference.

It is particularly proposed that the wheel element can be blocked in its rotation by means of a clamping element. The second force-limiting device thus comprises a clamping element, which can preferably be driven by the pyrotechnic drive. In the initial state, the clamping element is arranged at a distance from the wheel element, which is designed in particular as a gear wheel. The pyrotechnic drive allows the clamping element to be moved towards the rotating wheel element so that the teeth of the wheel element engage with the clamping element. Thus, the clamping element is initially entrained along by the rotating wheel element.

In this context, it is in particular provided that a housing surrounding the wheel element has a clamping design. The clamping design is arranged and designed such that the clamping element entrained along by the wheel element comes into or onto the clamping design so that the clamping element in engagement with the teeth of the wheel element is prevented from moving further, so that the rotation of the wheel element is also blocked. For example, the clamping design can be designed as a recess in the housing, into which the clamping element is entrained by the wheel element, the clamping element in particular coming up against a stop. Alternatively, it can be provided that the clamping design has a starting slope along which the clamping element is initially entrained by the wheel element, the starting slope displacing the clamping element and thus also the wheel element transversely to the axis of rotation of the wheel element, whereby a blockage of the wheel element occurs.

It can further be provided that the second force-limiting device comprises a driver which, in the coupled state, drives a force-limiting element and rotates with the belt shaft and/or the first force-limiting device. For example, the driver can be connected to a deformable belt serving as a force-limiting element, which in the coupled state is driven by the driver during the force-limited relative rotation, the force-limiting element providing the force-limiting effect of the second force-limiting device through the deformation work.

Thus, in one embodiment, it can be provided that a belt acting as a force-limiting element is coupled to the driver and to the wheel element. If the wheel element is now blocked in its rotation, in particular by means of the pyrotechnic drive and the clamping element, the driver continues to rotate with respect to the fixed wheel element, whereby the belt is driven and deformed.

Alternatively, it can be provided that a driver, which drives a force-limiting element in the coupled state, is decoupled from the belt shaft in the initial state. In the initial state, the driver is therefore not driven by the belt shaft and/or the first force-limiting device, but is actively coupled to the belt shaft and/or the first force-limiting device. For this purpose, the driver can be coupled to the belt shaft, for example by means of pawls, the pawls being mounted in particular on a coupling ring which rotates with the belt shaft and/or the first force-limiting device and is connected to a wheel element in the initial state. For this purpose, the wheel element can, for example, have pin-like projections onto which the coupling ring with recesses is placed. If the wheel element is blocked in its rotation, for example by means of the pyrotechnically driven clamping element, the coupling ring breaks off from the wheel element because the coupling ring is connected non-rotatably to the belt shaft and/or the first force-limiting device. The subsequent relative rotation between the coupling ring and the wheel element causes the pawls to engage with locking projections on the wheel element.

Due to the relative rotation of the coupling ring relative to the blocked wheel element, the pawls are also brought into engagement with the driver, whereby the driver, which is initially held stationary, is driven to a rotational movement together with the coupling ring. The driver in turn is connected for example to a deformable belt element, the belt element in particular being pulled through a chicane, whereby deformation work is performed which provides the force-limiting contribution of the second force-limiting device.

In one embodiment, the second force-limiting device can be arranged between the profile head and the belt shaft. Alternatively, the second force-limiting device can be arranged on a side of the belt shaft opposite the profile head. In principle, it would also be possible to provide two second force-limiting devices, the force-limiting devices being arranged on opposite sides of the belt shaft. This allows an ideal weight distribution of the entire belt retractor to be set.

For a compact design of the belt retractor, it is proposed that a pyrotechnic drive of the first force-limiting device and a pyrotechnic drive of the second force-limiting device are arranged in a common housing.

Alternatively, it can be provided that a pyrotechnic drive of the first force-limiting device and a pyrotechnic drive of the second force-limiting device are arranged in separate housings. In this connection, it is also proposed that the belt retractor is designed for modular extension. Depending on the application, the belt retractor can be extended by the second force-limiting device. For this purpose, the second force-limiting device, which has the housing for accommodating the pyrotechnic drive, can be plugged onto at least one component (for example an element—such as a torsion bar—of the first force-limiting device and/or the belt shaft). The belt retractor is therefore modularly extendable, the second force-limiting device having connection designs that are complementary to corresponding connection designs of the rest of the belt retractor.

The invention and the technical environment are explained below by way of example with reference to the figures. Schematically, in the figures:

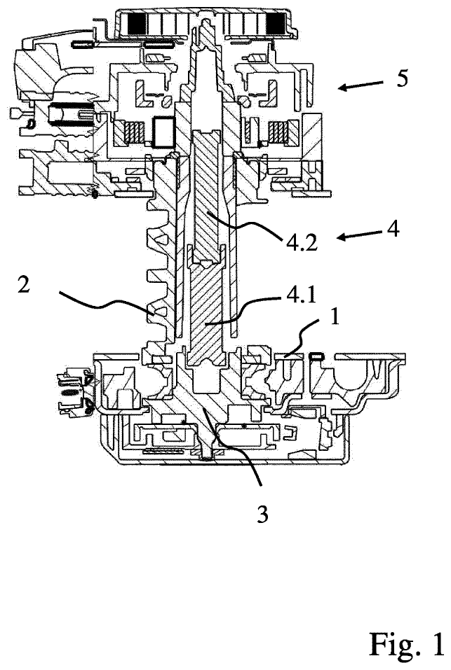

FIG. 1: is a sectional view through a belt retractor,

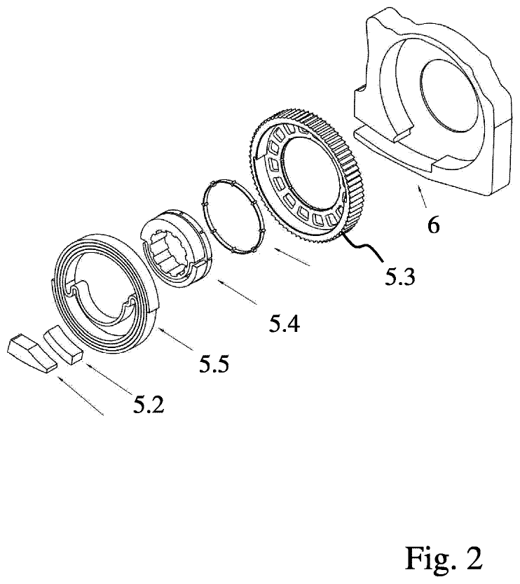

FIG. 2: is an exploded view of a first embodiment of a second force-limiting device,

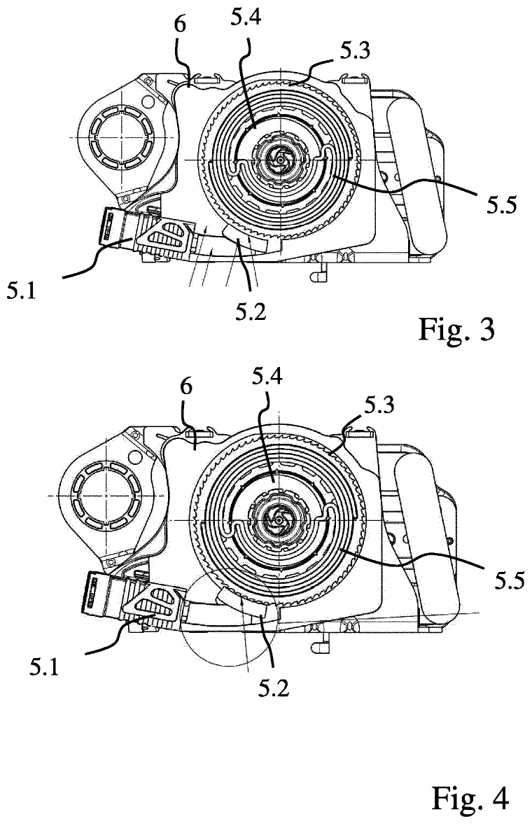

FIG. 3: is a plan view of the second force-limiting device in an initial state,

FIG. 4: is a plan view of the second force-limiting device in a coupled state,

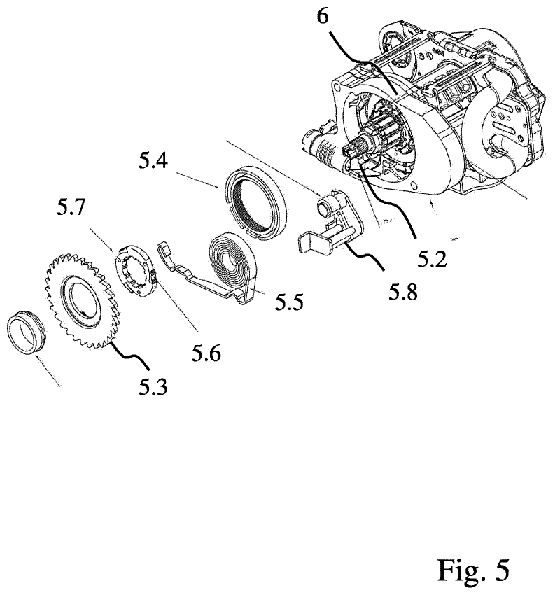

FIG. 5: is an exploded view of a second embodiment of a second force-limiting device,

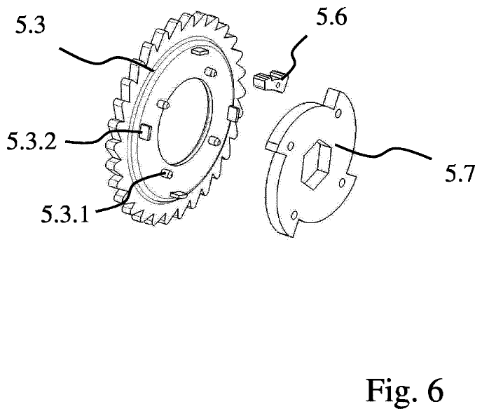

FIG. 6: is a perspective view of components of the second force-limiting device according to FIG. 5,

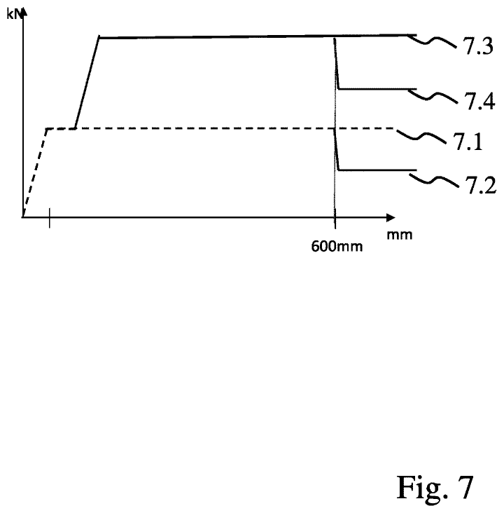

FIG. 7: is a graph illustrating possible force-limiting levels.

The belt retractor shown in FIG. 1 comprises a belt shaft 2 which is rotatably mounted in a housing frame 1. The belt shaft 2 is non-rotatably connected to a profile head 3. In order to initiate a force-limited relative rotation of the belt shaft 2 with respect to the housing frame 1, the profile head 3 can be locked in a known manner so that it no longer rotates relative to the housing frame 1.

The belt retractor comprises a multi-stage first force-limiting device 4, which comprises a first torsion bar 4.1 and a second torsion bar 4.2. The multi-stage first force-limiting device 4 also comprises a switching device known per se, so that the force-limited relative rotation of the belt shaft 2 with respect to the locked profile head 3 can take place either with both torsion bars 4.1 and 4.2 or only with one of the torsion bars.

The belt retractor also comprises a second force-limiting device 5.

A first embodiment of a second force-limiting device 5 is shown in FIGS. 2 to 4. The second force-limiting device comprises a wheel element 5.3 having external teeth, a driver 5.4, a force-limiting element 5.5 designed as a belt, and a clamping element 5.2, which can be driven by means of a pyrotechnic drive 5.1 (see in particular FIG. 3). The pyrotechnic drive 5.1 of the second force-limiting device 5 is arranged in a common housing 6, in which a pyrotechnic drive for the switching device of the first force-limiting device 4 is also arranged. Alternatively, the pyrotechnic drives can also be arranged in separate housings, which allows for a modular design.

The driver 5.4 is connected non-rotatably to the second torsion bar 4.2 of the first force-limiting device. In the initial state, the wheel element 5.3 rotates due to the connection via the belt 5.5 with the driver 5.4.

If the pyrotechnic drive 5.1 is now triggered, the clamping element 5.2, which, in the initial state, is at a distance from the gear wheels of the wheel element 5.3 (see in particular FIG. 3), is pressed onto the wheel element 5.3 (see FIG. 4). The teeth of the wheel element 5.3 engage with the clamping element 5.2. Since the clamping element 5.2 cannot follow the rotational movement due to its contact with the housing, the wheel element 5.3 is blocked. Subsequently, a relative rotation of the driver 5.4 thus takes place with respect to the blocked wheel element 5.3, as a result of which the force-limiting element 5.5 is deformed. In this way, an additional force-limiting level is provided by the second force-limiting device 5.

The embodiment shown in FIG. 5 comprises a chicane 5.8 through which a belt 5.5 designed as a force-limiting element can be pulled. The belt 5.5 is connected to a driver 5.4, which in the initial state does not rotate with the belt shaft 2 and/or the first force-limiting device 4.

The second force-limiting device of FIG. 5 also has a coupling ring 5.7 and pawls 5.6. In an initial state, the coupling ring 5.7 is connected non-rotatably to the wheel element 5.3. For this purpose, the coupling ring 5.7 is placed on pins 5.3.1 on the wheel element 5.3 (see FIG. 6). The coupling ring 5.7 is connected non-rotatably to the second torsion bar 4.2 of the first force-limiting device 4, so that in the initial state the wheel element 5.3 rotates together with the coupling ring 5.7.

If the wheel element 5.3 is now blocked by the clamping element 5.2 (similar to the embodiment in FIG. 2), the pins 5.3.1 break off from the wheel element 5.3 and the coupling ring 5.7 continues to rotate relative to the blocked wheel element 5.3. As a result of this relative movement, the pawls 5.6 come into engagement with projections 5.3.2 on the wheel element 5.3, the pawls 5.6 in this state protruding beyond the outer circumference of the coupling ring 5.7 and engaging in a form-fitting design on the inside of the driver 5.4. In this state, the driver 5.4 rotates with the coupling ring 5.6 (5.7), whereby the belt 5.5 is pulled through the chicane 5.8. In this state, a force-limited relative rotation of the belt shaft thus occurs, with an involvement of the second force-limiting device 5.

FIG. 7 shows schematically and by way of example four force-limiting levels 7.1, 7.2, 7.3 and 7.4 which can be adjusted using a belt retractor according to the invention. The first force-limiting level 7.1 can be set by means of the multi-stage first force-limiting device 4 by involving both torsion bars 4.1 and 4.2 in the force-limited relative rotation. If one of the torsion bars 4.1 or 4.2 is decoupled by means of a switching device, then the second force-limiting level 7.2 is reached. If the second force-limiting device 5 is coupled, the two force limitation levels achievable by the first force-limiting device 4 can be increased, so that the third force-limiting level 7.3 and the fourth force-limiting level 7.4 can be set. Thus, in the force-limited relative rotation of the third force limitation level 7.3, both torsion bars 4.1 and 4.2 of the first force-limiting device 4 and the second force-limiting device 5 are involved, while in the force-limited relative rotation of the fourth force-limiting level 7.4, one of the two torsion bars 4.1 or 4.2 of the first force-limiting device 4 and the second force-limiting device 5 are involved. The four force-limiting levels can be set at different times or at the beginning of the relative rotation.

### LIST OF REFERENCE SIGNS

1 Housing frame
2 Belt shaft
3 Profile head
4 First force-limiting device
4.1 First torsion bar
4.2 Second torsion bar
5 Second force-limiting device
5.1 Pyrotechnic drive
5.2 Clamping element
5.3 Wheel element
5.3.1 Pin
5.3.2 Projection
5.4 Driver
5.5 Force-limiting element
5.6 Pawl
5.7 Coupling ring
5.8 Chicane
6 Housing
7.1 First force-limiting level
7.2 Second force-limiting level
7.3 Third force-limiting level
7.4 Fourth force-limiting level

1. A belt retractor for a seatbelt of a motor vehicle, comprising
a belt shaft rotatably mounted in a housing frame,
a profile head which can be locked with respect to the housing frame,
a multi-stage first force-limiting device, wherein the first force-limiting device can be coupled to the profile head and to the belt shaft, and wherein the first force-limiting device allows a force-limited relative rotation of the belt shaft with respect to the locked profile head, and
at least one second force-limiting device,
wherein
in an initial state, the second force-limiting device is decoupled, so that the force-limited relative rotation of the belt shaft with respect to the locked profile head takes place without a force-limited involvement of the second force-limiting device.

2. The belt retractor according to claim 1, wherein the second force-limiting device can be coupled to the profile head and to the belt shaft, so that in a coupled state the force-limited relative rotation of the belt shaft with respect to the locked profile head takes place with a force-limited involvement of the second force-limiting device.

3. The belt retractor according to claim 1, wherein the second force-limiting device comprises a pyrotechnic drive by means of which a transfer of the belt retractor from the initial state into a coupled state can be triggered.

4. The belt retractor according to claim 1, wherein the second force-limiting device comprises a clamping element which can in particular be driven pyrotechnically.

5. The belt retractor according to claim 1, wherein the second force-limiting device comprises a wheel element which is rotatably mounted with respect to the housing frame in the initial state and which is blocked in its rotation in a coupled state.

6. The belt retractor according to claim 1, wherein a driver, which drives a force-limiting element in the coupled state, rotates with the belt shaft and/or the first force-limiting device in the initial state.

7. The belt retractor according to claim 1, wherein a driver, which drives a force-limiting element in the coupled state, is decoupled from the belt shaft in the initial state.

8. The belt retractor according to claim 7, wherein the driver can be coupled to the belt shaft by means of pawls, wherein the pawls are mounted in particular on a coupling ring which rotates with the belt shaft and is connected to a wheel element in the initial state.

9. The belt retractor according to claim 1, wherein the second force-limiting device is arranged between the profile head and the belt shaft or on a side of the belt shaft opposite the profile head.

10. The belt retractor according to claim 1, wherein the second force-limiting device comprises at least one belt, which deforms during the force limitation, as a force-limiting element.

11. The belt retractor according to claim 1, wherein a pyrotechnic drive of the first force-limiting device and a pyrotechnic drive of the second force-limiting device are arranged in separate housings.
